(19) United States
(12) Patent Application Publication
(10) Pub. No.: US 2016/0247130 A1
(43) Pub. Date: Aug. 25, 2016

(54) PRESENTING RECIPIENT BILLING INFORMATION USING DATA FROM PREVIOUS TRANSACTIONS

(71) Applicants: John Paul Olmstead, San Anselmo, CA (US); Michael D. Osborne, Berkeley, CA (US); Christian Saravia, Guatemala City (GT)

(72) Inventors: John Paul Olmstead, San Anselmo, CA (US); Michael D. Osborne, Berkeley, CA (US); Christian Saravia, Guatemala City (GT)

(21) Appl. No.: 15/052,755

(22) Filed: Feb. 24, 2016

Related U.S. Application Data
(60) Provisional application No. 62/120,287, filed on Feb. 24, 2015.

(51) Int. Cl. G06Q 20/10; G06Q 20/40

(52) U.S. Cl. CPC G06Q 20/102; G06Q 20/401

(57) ABSTRACT

A method and apparatus for displaying presenting billing information of an electronic funds transfer recipient is provided. In an embodiment, a method comprises storing recipient information when a customer makes a financial transfer; requesting billing information from one or more billing companies for one or more accounts associated with the stored recipient information; storing account balance information for the one or more accounts associated with the stored recipient information; displaying, upon receipt of login information from the customer, the billing information and an option to pay the displayed bill; receiving authorization to pay the displayed bill; and causing one or more computers to execute payment of the bill using a payment account of the customer.

### BENEFIT CLAIM

This application claims the benefit under 35 U.S.C. §119(e) of provisional application 62/120,287, filed Feb. 24, 2015, the entire contents of which is hereby incorporated by reference for all purposes as if fully set forth herein.

### FIELD OF THE DISCLOSURE

The present disclosure relates to software that is configured to process electronic funds transfers and communicate with billing servers and techniques for retrieving billing information for recipient accounts.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Electronic funds transfer transactions may be used to move money from one account to another over arbitrary distances. Electronic funds transfers are gaining popularity among consumers for sending or receiving money to or from family or friends. Often, consumers will send money to recipients for specific purposes, such as to help the recipient pay bills. Other times, consumers may not be aware that the recipient has unpaid bills coming due.

While electronic funds transfers are useful for allowing consumers to send funds across great distances, they only exist as a tool to reach a result. Modern day electronic funds transfers do not provide the consumer with any information regarding the recipient. Additionally, if a consumer wishes to transfer funds to a recipient for a specific purpose, such as to help the recipient pay a bill, the consumer cannot be assured that the transferred money will be used for the designated purpose. A consumer currently has no way of determining, without receiving information directly from the recipient, whether there are any outstanding bills of the recipient.

Thus, there is a need for a system which informs a funds transferor of unpaid bills or a recipient and facilitates the payment of the unpaid bills.

### BRIEF DESCRIPTION OF THE DRAWINGS

In the drawings:

FIG. 1A depicts a computer system that may be used to implement techniques for expediting electronic funds transfers.

FIG. 1B depicts example internal logic of the payment management service computer of FIG. 1A.

FIG. 2 depicts a process of displaying accounts that are eligible for payment.

FIG. 3 depicts an example user interface for displaying an account balance to a transferor.

FIG. 4 depicts a second example user interface for displaying an account balance to a transferor.

FIG. 5 depicts an example authorization interface.

FIG. 6A depicts an example data flow and user flow according to some embodiments.

FIG. 6B depicts an example data flow and user flow according to some embodiments.

FIG. 7 is a block diagram that depicts a computer system 800 upon which embodiments may be implemented.

### DETAILED DESCRIPTION

In the following description, for the purposes of explanation, numerous specific details are set forth in order to provide a thorough understanding of the present disclosure. It will be apparent, however, that embodiments may be practiced without these specific details. In other instances, well-known structures and devices are shown in block diagram form in order to avoid unnecessarily obscuring the present disclosure.

General Overview

In one embodiment, a data processing method comprises initially storing recipient information from one or more financial transfers; requesting account balance information from one or more billing companies using the stored recipient information; receiving login information of a transferor; causing display of the account balance information and an option to pay an account balance associated with the account balance information; receiving authorization to pay the account balance; and causing one or more computers to execute payment of the account balance using a payment account of the transferor.

According to an embodiment, a data processing method comprises storing, in a data repository of a server computer, user account information comprising identification of a plurality of user accounts and authorization data for each account of the plurality of accounts; receiving, over a network at the server computer system, authentication data for a particular user of the plurality of users; receiving, over a network at the server computer system, a request from the particular user account to transfer funds to a particular recipient; in response to the request to transfer funds, storing, in a data repository of the server computer, particular recipient information comprising an identification of the particular recipient and an association between the particular recipient and the particular user; using the particular recipient information, sending, over a network from the server computer system, a request to an application programming interface of one or more product or service providers for particular recipient account information for one or more particular recipient accounts with the one or more product or service providers; receiving, over a network through the application programming interface of the one or more product or service providers, particular recipient account information for the one or more particular recipient accounts and storing the particular recipient account information in a data repository of the server computer system; receiving, over a network at the server computer system, authentication data for the particular user; in response to receiving the authentication data for the particular user, identifying the particular recipient based, at least in part, on the stored association between the particular recipient and the particular user; in response to identifying the particular recipient, determining, from the particular recipient account information, that the one or more particular recipient accounts have a current balance; and causing displaying, through a graphical user interface executing on a client device associated with the particular user, a selectable option to pay a bill of the particular recipient.

In other embodiments, a computer-readable storage medium stores instructions which when executed cause one or more processors to perform the foregoing operations. Other embodiments may include special-purpose computers that are programmed or feature logic executable to perform the foregoing operations. Still other embodiments are shown and described and will be apparent from the disclosure as a whole.

Structural and Functional Overview

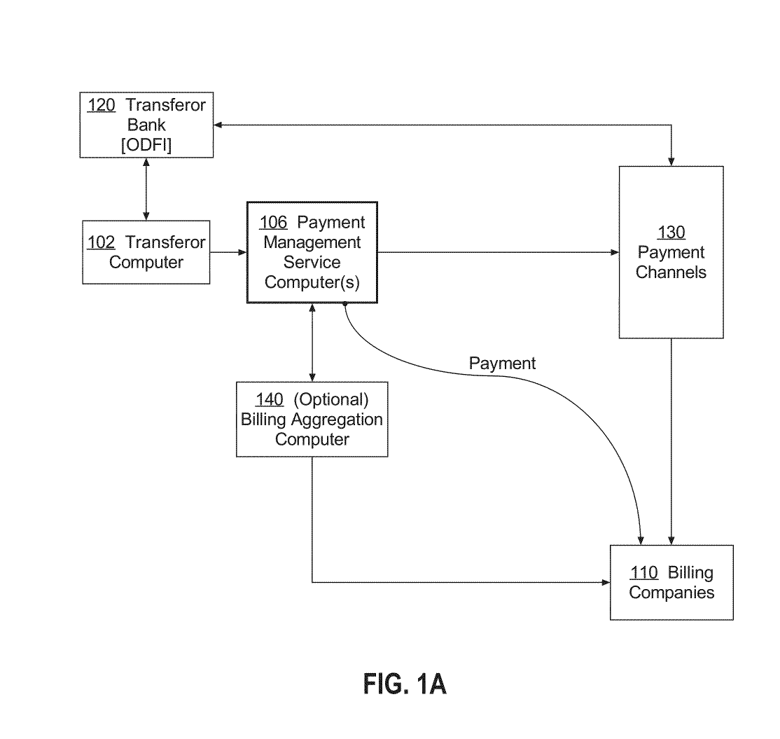

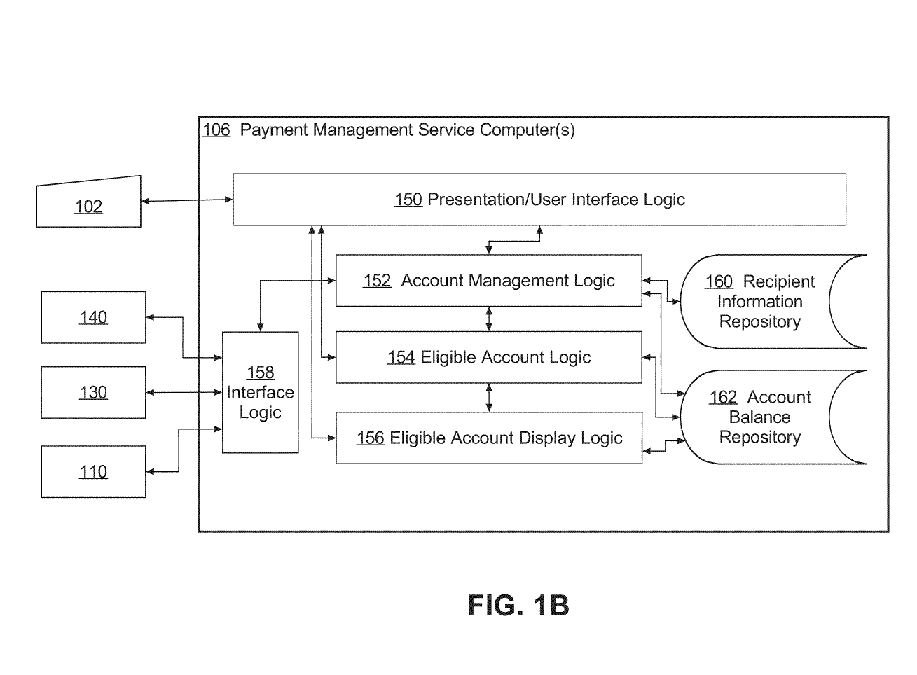

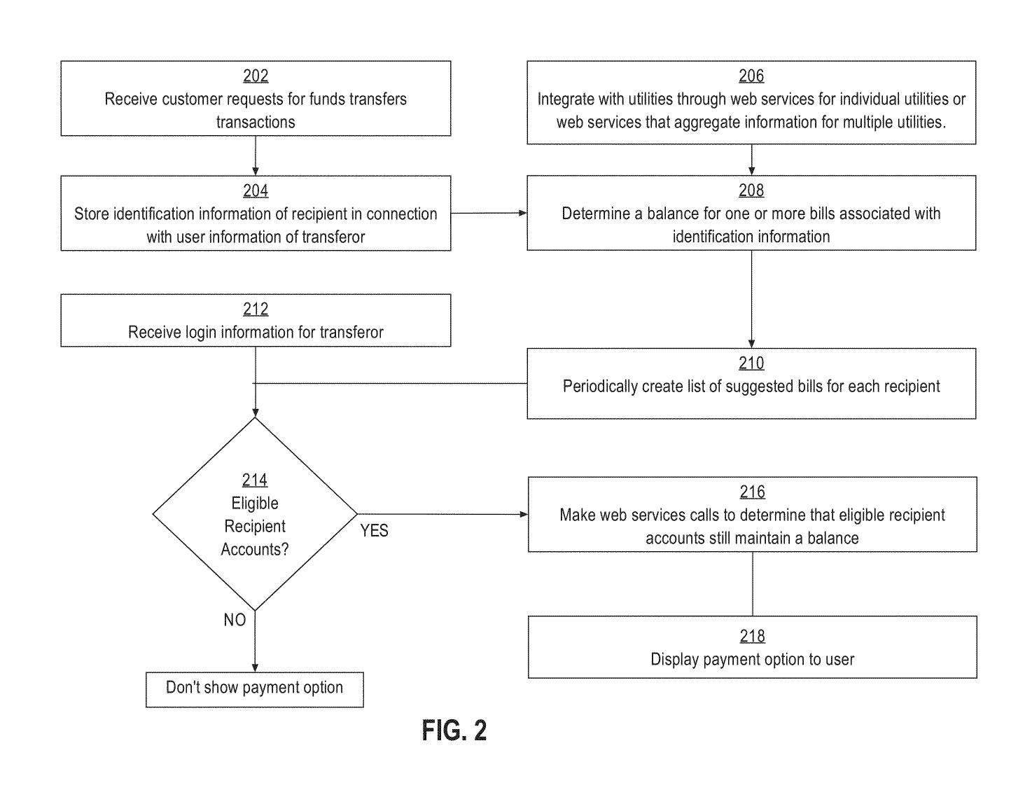

FIG. 1A depicts a computer system that may be used to implement techniques for expediting electronic funds transfers; FIG. 1B depicts example internal logic of the payment management service computer of FIG. 1A; FIG. 2 depicts a process of displaying accounts that are eligible for payment. In an embodiment, the techniques herein are used in the context of determining whether the recipient of a funds transfer has one or more account balances that may be paid by the transferor. Each of the transferor and recipient may be an individual, business, or other entity. The recipient may be geographically distant from the transferor, for example, in a different country. Thus the transaction may be an international money transfer to a different country and having different currencies associated with the transferor's country and the recipient's country.

Referring first to FIG. 1A, in an embodiment, a transferor computer 102 is communicatively coupled, directly or indirectly through one or more networks, to a payment management service computer 106. Typically transferor computer 102 is a laptop, netbook, mobile device, personal computer or workstation associated with an individual user of a money transfer service hosted on computer 106, and the payment management service computer is a server-class computer or multiple computers in a data center. Computers 102, 106 may be coupled using any of a LAN, WAN, or one or more internetworks, and each arrow shown in FIG. 1A with a straight line may represent a network link using any of a LAN, WAN, or one or more internetworks.

A bank 120, at which the transferor has deposited money or has an account, acts as an originating depository financial institution (ODFI). In an embodiment, payment management service computer 106 acts as an automated clearing house (ACH) transaction originator using the techniques that are further described herein. The term “ACH” in this disclosure refers broadly to any transaction clearing system or operator of the kind described in at least this paragraph and the preceding paragraph.

Billing companies 110 are companies that charge one or more recipients for services. Billing companies 110 may include phone companies, utility companies, credit card companies, and other product or service based companies. Payment management service computer 106 and billing aggregation computer 140 may interact with billing companies 110 through one or more computers operated by billing companies 110. Computer 106 and computer 140 may be communicatively coupled to the computers operated by billing companies 110 directly or indirectly through one or more networks.

Billing aggregation computer 140 is communicatively coupled, directly or indirectly through one or more networks, to payment management service computer 106 and billing companies 110. In an embodiment, billing aggregation computer 140 receives and stores aggregated account information for multiple billing companies of billing companies 110.

Payment channels 130 may be any method of paying for services using ODFI account information. Payment channels 130 may include ACH, net settlement, or other common payment methods using bank account or credit information. In an embodiment, payment management service computer 106 may use payment channels 130 to cause a payment from transfer bank 120 to billing companies 110.

Referring now to FIG. 1B, in an embodiment, payment management service computer 106 comprises presentation/user interface logic 150 that is configured to generate a user interface for a payment service for display at client computers such as transferor computer 102. For example, presentation/user interface logic 150 may be configured to generate a graphical user interface in the form of static or dynamic HTML pages that are delivered to and rendered by a browser hosted on transferor computer 102. Additionally or alternatively, transferor computer may host a locally installed client application that interacts with the presentation layer of a server application system hosted at payment management service computer 106.

Payment management service computer 106 further comprises account management logic 152 coupled to presentation/user interface logic 150, interface logic 158, recipient information repository 160, and account balance repository 162. Account management logic 152 is configured to receive user input through presentation/user interface logic 150 that identifies one or more recipients and includes additional information about the one or more recipients such as a mobile phone number or address. Account management logic 152 is configured to store the recipient information in recipient information repository 160.

Account management logic 152 is further configured to retrieve specific types of information from recipient information repository 160, such as mobile phone numbers. In an embodiment, account management logic interacts with billing companies 110 and billing aggregation computer 140 through interface logic 158. In an embodiment, account management logic 152 is configured to request, from either computer 110 or computer 140, account information related to the retrieved recipient information for one or more recipients. Account management logic 152 may be further configured to store retrieved account information in account balance repository 162.

In an embodiment, account management logic 152 is configured to interact with payment channels 130 in order to facilitate the payment of account balances with billing companies 110. Account management logic 152 may also be configured to update account balance repository to indicate that a payment has been made with respect to a recipient account.

Eligible account logic 154 is configured to receive transferor identification from presentation/user interface logic 150 and retrieve account data for related recipient accounts from account balance repository 162. Eligible account logic 154 is further configured to determine if one or more accounts listed in account balance repository 162 contain a current balance. Eligible account display logic 154 is configured to apply one or more prioritization rules to determine one or more eligible accounts to display to computer 102 through presentation/user interface logic 150.

The interface logic 158 is configured to transform requests from logical elements 152, 154, and 156 into transactions, messages, packets, or frames that conform to protocols used in financial payment networks such as the ACH system

Account Balance Determination

FIG. 2 depicts a process of displaying accounts that are eligible for payment. At step 202, transferor requests for funds transfer transactions are received. For example, payment management service computer 106 may interact with a user in the position of a customer of a payment server in the following manner. The payment management service computer 106 receives an HTTP request over an internetwork from transferor computer 102 and delivers an HTML form with which a user of the transferor computer selects a country to which the user wishes to send money. The user selects a country and submits the form to the payment management service computer 106 using an HTTP POST request. In response, the payment management service computer 106 prompts the user to log in or to establish an account associated with an e-mail address and a password. The user may provide login credentials for authentication, or may submit account details to create a new account with a private password, after which the user is automatically logged in.

Once the user has logged in, payment management service computer 106 generates and provides an HTML form in which the user enters data to identify a recipient's bank and to identify the recipient of the transferred money. The user submits the completed form to the payment management service computer 106, which may validate data in the form such as bank name, account number, routing number, sort code, address, postal code, telephone, and e-mail address.

If the data validates, then the payment management service computer 106 may generate and provide the user with a form in which the user enters payment information such as bank account details associated with an account at transferor bank 120. The payment management service computer 106 may also provide a data confirmation form that prompts the user to review and confirm details of the transaction before the transaction proceeds. The foregoing process may be implemented using presentation/user interface logic 150 in the example embodiment of FIG. 1B, in cooperation with authentication logic and validation logic integrated into presentation/user interface logic 150 or other elements.

In an embodiment, the user of transferor computer 102 may input identification information of the recipient. For example, the user interface may include a form for recipient data, such as the recipient's name, address, telephone number, or email address. In an embodiment, the user interface includes a request for the identification information in order to send confirmation to the recipient. For example, a customer may enter the telephone number of the recipient in order to allow payment management service computer 106 to send an SMS message to the recipient phone to notify the recipient of the transfer of funds.

At step 204, computer 106 stores the identification information of the recipient in recipient information repository 160 in connection with the user information of the transferor. For example, if the transferor logs into the system with a unique identifier, the unique identifier may be associated with one or more recipients in recipient information repository 160. Recipient information repository 160 may comprise records for each recipient, each of which may contain identification information such as the recipient's name, address, and phone number, transfer information such as the date, time, and amount of each transfer, and transferor identification information such as the unique identifier of the transferor. Alternatively, recipient information repository 160 may only include recipient records and the transfer and transferor records may be stored in a separate data structure.

At step 206, computer 106 uses account management logic 152 to integrate with billing companies 110. Account management logic may contain application program interfaces (APIs) which access web services for each of billing companies 110 through interface logic 158. Alternatively, account management logic 152 may connect to billing aggregation computer 120 in order to receive information from multiple billing companies.

At step 208, computer 106 uses account management logic 152 to determine a balance for one or more bills associated with identification information stored in recipient information repository 160. For example, recipient information stored in recipient information repository 160 may include the phone number of a recipient which was initially used to send transfer confirmation to the recipient. Account management logic 152 may determine that the phone number of the recipient matches customer records for a specific phone company by making web service calls to either the phone company's server or to billing aggregation computer 120 which contains information for multiple phone companies. Upon determining an account with a particular phone company matches the phone number of the recipient, account management logic 152 may send a request through interface logic 158 to either computer 110 or computer 140 for current billing records related to the recipient's account.

At step 210, computer 106 periodically creates a list of suggested bills for each recipient. Creating the list may include determining a number of accounts related to the stored recipient information, determining that one or more accounts contain a current balance, and storing the current balance information for each account in account balance repository 162. Account balance repository 162 may be a database configured to maintain account balances for recipient accounts. Account balance repository 162 may contain identifications of each recipient account, an indication as to whether each account has a current balance due, the amount due for each account, identification of the billing company for each account, an account type, and a link that can be accessed by the APIs of account management logic 152 to locate the web services that correspond to the billing company.

Determining accounts related to stored recipient information, determining whether each account contains a current balance, and storing current balance information for each account may be performed on a periodic basis. For example, account management logic 152 may be configured to wait until a specific time each day before running account queries with respect to all recipient information stored in recipient information repository 160. In an embodiment, account management logic 152 may bypass recipient information repository 160 when an account has already been identified. For example, account management logic 152 may be configured to store identified account information with the recipient information in recipient information repository 160. When account management logic 152 next accesses recipient information repository 160, account management logic 152 may use the identified account information instead of using the recipient information to locate the account.

At step 212, computer 106 receives login information for the original transferor. Login information may include a unique identifier and password entered in a user interface provided by presentation/user interface logic 150. Upon receiving the login information, account management logic 152 may identify the transferor and all related recipient accounts.

At step 214, eligible account logic 154 determines whether any of the recipient accounts are eligible to receive a bill payment. Eligible account logic 154 may access account balance repository 162 and search the account records for recipient accounts related to the transferor. In an embodiment, eligible account logic 154 takes the stored recipient information and searches the matching accounts for any bills that are currently due. For example, if the transferor has sent money to two recipients in the past, eligible account logic 154 may search the account balance repository 162 for any billing records associated with the two recipients. If only one of the records is marked as currently due, eligible account logic 154 may only return billing information for that account.

In an embodiment, eligible account display logic 156 may determine an ordering for the eligible accounts. For example, eligible account display logic 156 may be configured to select the eligible account with the lowest balance to be displayed first. In an embodiment, all eligible accounts are initially selected by eligible account logic 154, but only the accounts selected by eligible account display logic 156 are displayed to the user. In alternate embodiments, eligible account display logic 156 selects one or more accounts out of the eligible recipient accounts to use for the remaining steps of FIG. 2.

In an embodiment, if eligible account logic 154 determines that there are no eligible recipient accounts, eligible account display logic 156 may not show a payment option. Alternatively, eligible account display logic 156 may be configured to display a default bill pay window to allow the transferor to manually enter in account details. Account details entered in this way may be stored in account balance repository 162 as an additional recipient account related to the transferor.

At step 216, if eligible account logic 154 determines that one of the recipient accounts in account balance repository 162 is marked as containing a current balance, account management logic 152 may make a query to the billing company to determine if the balance is still active. In an embodiment, account management logic 152 saves on processing power and time by running queries only for the recipient accounts that are listed as containing an active balance in account balance repository 162. Running queries for all of the billing companies periodically allows computer 106 to more efficiently determine recipient accounts that contain a current balance at the time a transferor logs in to the system.

Determining whether the eligible recipient account maintains a current balance may involve computer 106 taking similar actions as in step 204. Account management logic 152 may query the billing company for the current status of accounts associated with either the recipient information stored in recipient information repository 160 or recipient account information stored in account balance repository 162.

Interface Implementations

At step 218, eligible account display logic 156 may choose one or more accounts to display to transferor computer 102. Eligible account display logic 156 may apply one or more rules to determine which of the eligible accounts to display. For example, eligible account display logic 156 may display the account with the lowest balance. In alternative embodiments, eligible account display logic 156 may choose to display accounts with the soonest due date or accounts that have been paid consistently by the transferor in the past. For example, if two recipient accounts, recipient A and recipient B are associated with the transferor, but the transferor has only paid the phone bill for recipient B in the past, eligible account display logic 156 may initially display the phone bill for recipient B regardless of the amount due on the two accounts. Alternatively, if recipient A's account has the lower balance, eligible account display logic 156 may be configured to display recipient A's account first.

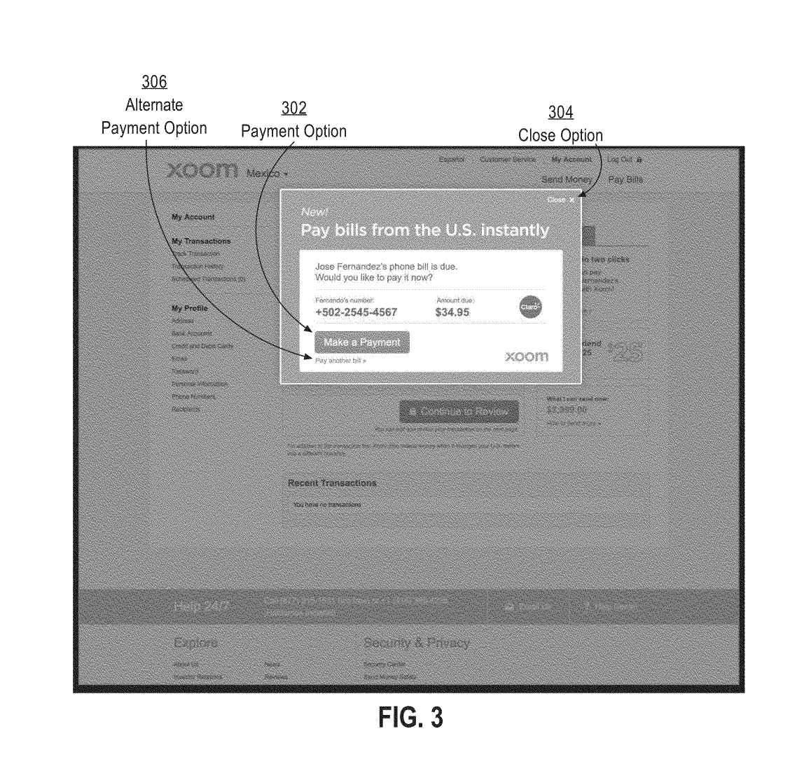

FIG. 3 depicts an example user interface for displaying an account balance to a transferor. FIG. 3 contains a modal window that may be displayed over a financial transfer interface. In an embodiment, presentation/user interface logic 150 may cause the financial transfer interface to darken when displaying the modal window. In an embodiment, a transferor may not interact with the financial transfer interface until the transferor has closed the modal window.

The modal window in FIG. 3 contains the name of the recipient, the phone number linked to the recipient's account, the amount due on the account, and an option to make a payment on the account. If the transferor selects the “make a payment” option, the transferor may be navigated to a separate payment page or a separate payment window. If the transferor chooses to not make a payment on the displayed account, the transferor may either select the “close” button located at the top right of the window in order to remove the bill payment option, or the “pay another bill” button located under the “make a payment” option.

In an embodiment, the “pay another bill” button causes eligible account logic 154 to determine the next eligible account for bill payment. In alternative embodiments where all eligible accounts are determined in advance and only one is displayed, eligible account display logic 156 may determine which of the remaining recipient accounts to display next. Eligible account display logic 156 may use the same rules to determine the next account to display, such as the account with the second lowest payment or the account with the second soonest due date. Alternatively, eligible account display logic 156 may use different rules for displaying the second account. For example, if the first account displayed is the account with the lowest balance due, the second account displayed may be the account on which the transferor has made payments consistently in the past.

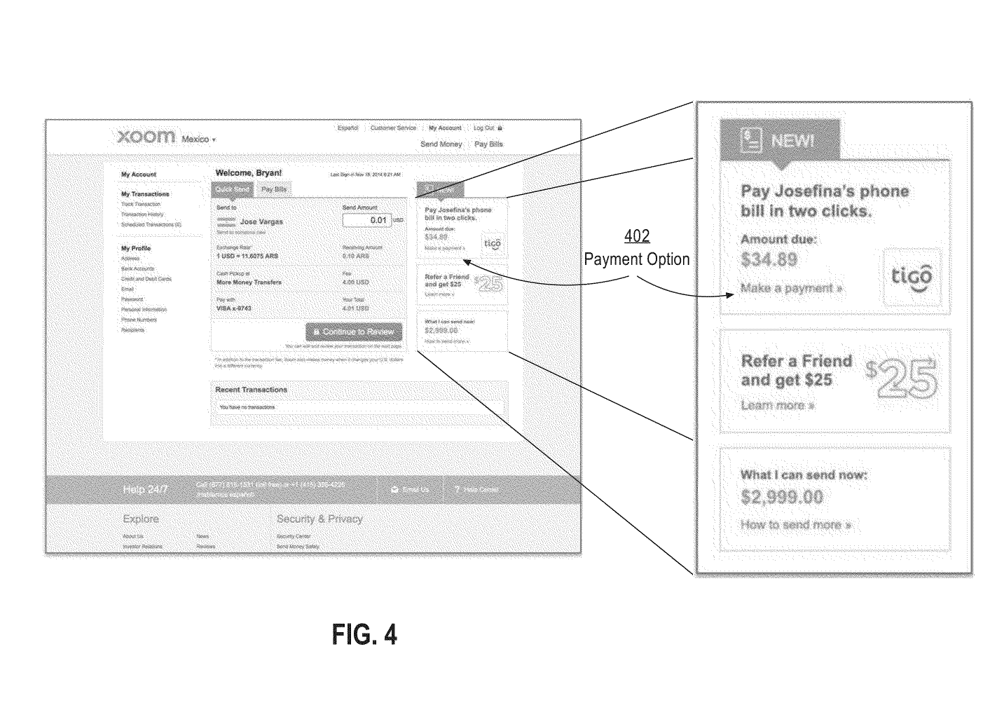

FIG. 4 depicts a second example user interface for displaying an account balance to a transferor. FIG. 4 contains a window with a financial transfer interface and a sidebar with a bill pay interface. The bill pay interface may include the name of the recipient, the type of bill to be paid, the amount due on the bill, and an option to pay the bill. In an embodiment, a “pay another bill” button may be located under the “make a payment” option. If the user selects the “pay another bill” button, the sidebar may refresh to display a different recipient account balance. Alternatively, selecting the “pay another bill” button may bring the transferor to a separate page that allows the transferor to manually enter in account information for a recipient.

While FIG. 3 and FIG. 4 depict a single displayed account balance, in alternate embodiments the display may include multiple account balances. For example, the sidebar of FIG. 4 may contain multiple bill pay options for either a single recipient or multiple recipients. In some embodiments, a transferor may be given the option of configuring the sidebar or modal window to display more bills, less bills, certain types of bills, or bills for specific recipients. For example, the modal window of FIG. 3 may contain drop down menus that allow the transferor to select a recipient, a type of bill, or a specific eligible bill for a recipient. Upon making a selection, the modal window may update to show one or more bills that correspond to the transferor's selection.

Once a user chooses to make a payment, account management logic 152 may make a final query to the billing company to ensure that the account information presented to the transferor is accurate. The final query may include a request for a current account balance to ensure that the no changes have been made to the recipient account and that the bill is still eligible to be paid. If account management logic 152 determines that the bill is still eligible to be paid, presentation/user interface logic 150 may navigate the transferor to an authorization interface.

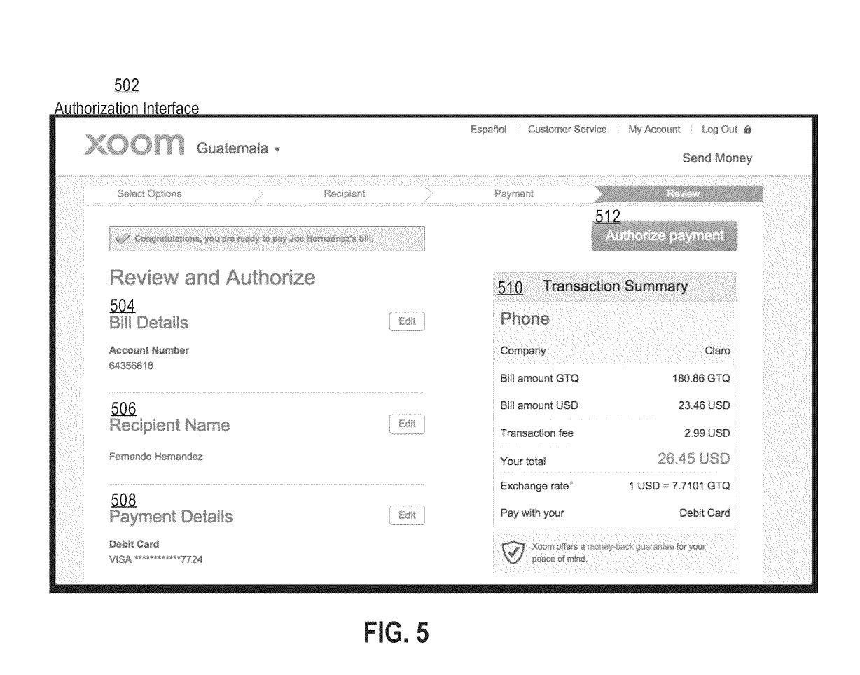

FIG. 5 depicts an example authorization interface. Authorization interface 502 includes bill details 504, recipient identification 506, payment details 508, transaction summary 510, and authorization button 512. In an embodiment, presentation/user interface logic 152 pre-fills all of the transaction data using stored information. For example, payment details 508 may be predetermined using the transferor's entered account information from one or more prior transfers. If the transferor has used multiple payment accounts in prior transfers, multiple options may be displayed under payment details with one selected as a default. Alternatively, the default payment option may be the only payment option displayed and the transferor may change payment options using the “Edit” button next to the payment details.

By pre-filling the form with payment information and account information, presentation/user interface logic 152 allows the transferor to complete the transaction with minimal effort. As long as the transferor intends to use the previously stored payment account information, the transferor may complete the transaction by selecting the “authorize payment” button.

While FIG. 5 depicts a new window for payment authorization, in alternative embodiments the transferor does not navigate to a new window to authorize the payment. For example, a modal window may include the authorization details and an “authorize payment” button. In an embodiment, the modal window of FIG. 3 updates when the transferor selects the “make a payment” option to show the default options for paying the account balance. If the transferor chooses to make changes, such as lowering the amount paid or changing the payment options, the transferor may select an edit option which brings the transferor to a new window for changing the requested information. In another embodiment, the sidebar of FIG. 4 may update when the transferor selects the “make a payment” option to provide summary details of the transaction, such as the payment account, the billing company name, and the amount of the transaction. An option for additional details may be included to allow the transferor to view additional transaction information or edit the transaction. The sidebar may also include an “authorize payment” button for finalizing the transaction.

Once the transferor has selected the “authorize payment” option, account management logic 152 may use the payment information to pay the bill with the billing company through payment channels 130. Upon paying the bill, account management logic 152 may update account balance repository 162 to include the updated account information. Account management logic 152 may also remove the paid account from the list of eligible accounts to ensure that the transferor is not given the option to repay the paid bill.

In an embodiment, the transferor is navigated back to the original financial transfer interface after successfully completing a bill payment. In other embodiment, presentation/user interface logic 150 displays a “pay another bill” option to the transferor after the transferor completes the transaction. Upon selecting the “pay another bill” option, eligible account display logic 156 may determine one or more remaining eligible bills to display to the transferor. In some embodiments, the “pay another bill” option is related to a specific eligible bill. For example, after the transferor finishes paying the bill for recipient A, presentation/user interface logic 156 may display an option for paying a bill for recipient B.

In an embodiment, after the transferor navigates back to the financial transfer interface, eligible account logic 154 determines whether any eligible accounts remain. If eligible account logic 154 determines that there are remaining eligible accounts, presentation/user interface logic 150 may display the new eligible account through the previously used method. For example, if the modal window of FIG. 3 was originally displayed to the transferor, then presentation/user interface logic 150 may cause a new modal window relating to the next eligible account to be displayed to the transferor upon completion of the first transaction. If the sidebar of FIG. 5 was originally displayed to the transferor, then presentation/user interface logic 150 may cause a new sidebar relating to the next eligible account to be displayed.

In embodiments where the transferor is not navigated to a new window to authorize the transaction, presentation/user interface logic 150 may update the bill payment interface to display the next eligible bill. For example, if the sidebar of FIG. 4 was initially used to display the bill and to authorize payment of the bill, the sidebar may refresh after the bill authorization to display the next eligible bill. Using this method, presentation/user interface logic 150 may minimize the effort for a transferor to pay multiple bills for multiple recipients.

Additional Implementations

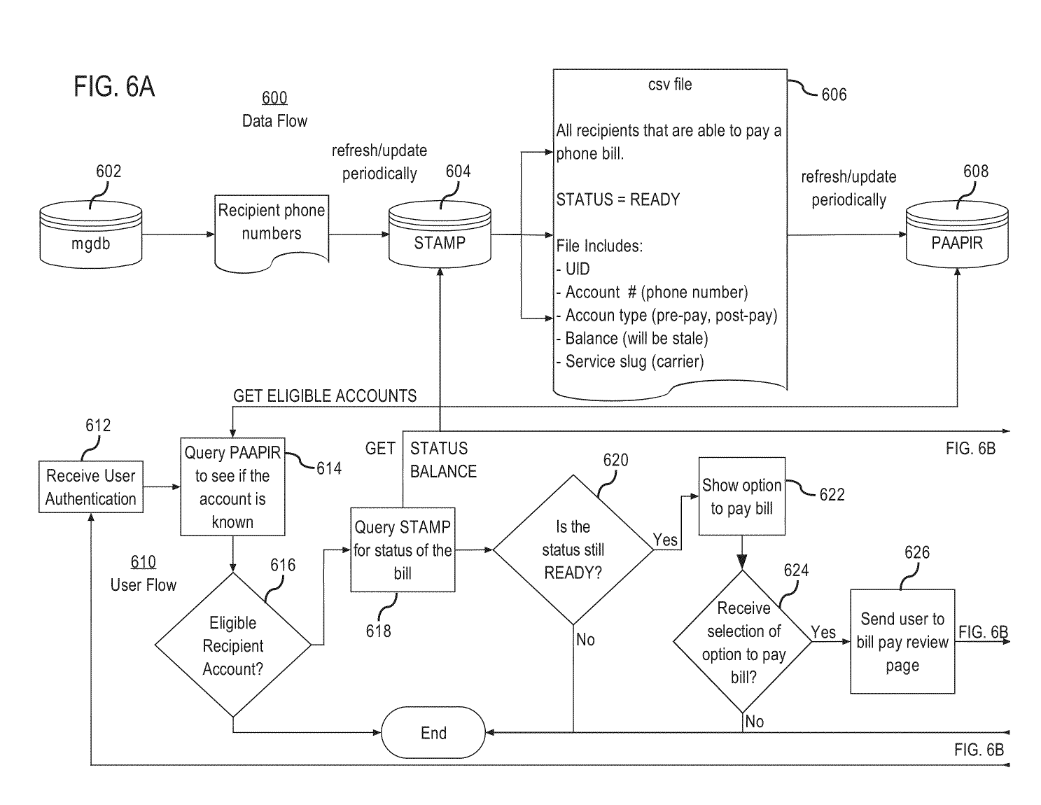

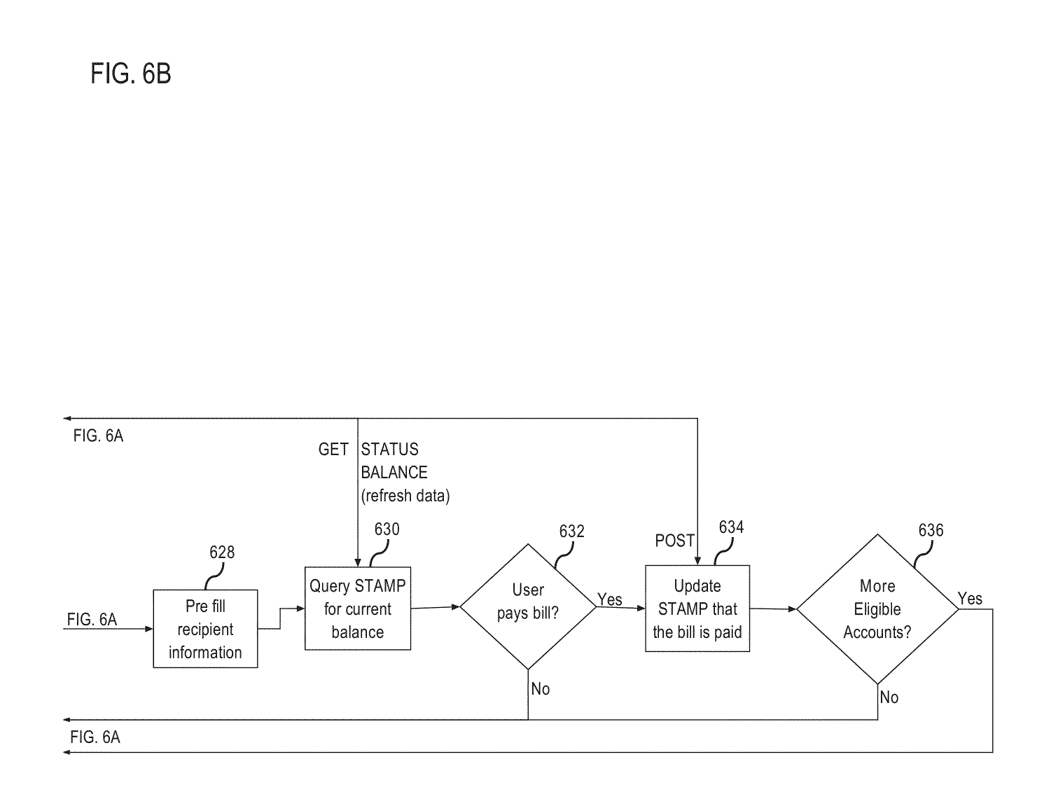

FIG. 6A and FIG. 6B depict an example computer-implemented data flow and user flow according to certain embodiments. FIG. 6A includes a data flow diagram showing, in part, computer system elements that may be used in an implementation with networked distributed computers, and a user flow diagram. Referring first to data flow 600, in an embodiment, recipient information, such as phone numbers and addresses, is stored in database 602 titled “mgdb.” The database name is arbitrary. In an embodiment, a file is created with the recipient information and sent periodically to database 604, titled “STAMP” in this example. In some embodiments, the information is sent to the STAMP database automatically while in other embodiments the information is manually extracted from the mgdb database and sent to the STAMP database.

In an embodiment, the STAMP database is configured to match phone numbers with values in existing records of institutions such as utilities using APIs that interact with utility web services. For example, the STAMP database may be coupled to a computer that is programmed to transmit web services calls to defined APIs of a plurality of computers at utilities or other institutions.

Once the STAMP database has matched the phone numbers with values in existing records of institutions such as utilities, the STAMP database generates one or more files 606 that contain records that associate the user ID of the transferor, the account number of the recipient, the account type of the recipient, the balance of the recipient account, and a service slug which may comprise a graphical file that identifies a logo, name or design of the particular service for the utility bill. One or more files 606 generated by the STAMP database may then be uploaded to analytics computer 608, titled “PAAPIR.” The file is then available through the PAAPIR computer to be used by other applications.

The architecture thus described offers numerous technological benefits. The architecture effectively stages, in the PAAPIR database, data records of accounts that may be eligible for payment at utilities or other institutions, permitting other elements of the system to rapidly and efficiently retrieve the records without requiring a connection or request to the utilities themselves. The PAAPIR database may be housed in the same data center as the user interface application. This arrangement permits far faster response and analysis. A call to PAAPIR from the user interface application is much faster and more efficient than making calls to the STAMP database which may be housed separately to optimize the integration with the utility companies and may require additional authentication.

Referring to user flow 610, in an embodiment, at step 612, user authentication is received. For example, a user computer may navigate to the system's website and enters in login credentials. The system authenticates the user computer through the entered login credentials. At step 614, PAAPIR is queried to determine if the account is known. For example, once the authentication process is complete, the system sends a call to PAAPIR to determine if there are any eligible billing accounts for the user to pay. PAAPIR may then return a list of recipients that currently have payable utility bills. In one embodiment, the system may then select the bill with the lowest current balance to be displayed to the user, but in other embodiments, all available bills could be presented. Presentation of the payable utility bill may include summary information and may include hyperlinks, graphical buttons or other widgets that permit selecting one particular available bill.

In an embodiment, an eligible bill is selected from the PAAPIR database for display to the user. The system may be configured to select, from all bills with current balances in PAAPIR, a bill with the lowest balance, a bill with the soonest due date, a bill corresponding to a priority recipient, or a bill that meets one or more other metrics. At 616, a determination is made whether there is an eligible recipient account. If, at step 616, an eligible recipient account is selected, at step 618 the system sends a query to STAMP to determine if the status of the account in STAMP matches the status of the account in PAAPIR. In an embodiment, paying a bill through the system causes a change of status for the bill in STAMP, but not in PAAPIR which updates periodically. Thus, in some situations the status of the account in PAAPIR may differ from the status of the account in STAMP.

At step 620, the system determines whether the status of the bill indicates that the bill is ready to be paid. If the system determines that the bill is ready to be paid, at step 622, an option to pay the bill is displayed. For example, a promotion may be generated to be displayed using a user computer, and which includes bill information such as the name of the recipient, the type of bill, and the amount of the bill. Embodiments include the modal window of FIG. 3 and the sidebar of FIG. 4.

At step 624, the system determines whether input has been received selecting an option to pay the bill. For example, digital data input then is received representing a selection of a bill to be paid, from the user computer. In an embodiment, when the user computer selects the bill to be paid, at step 626 the user computer is sent a bill review page that is configured to receive data to authorize the payment of the bill. Referring to FIG. 6B, which continues the user flow from FIG. 6A, the system confirms all of the bill payment information. Confirming the bill payment information may include determining whether the user payment account is still active and whether the bill is capable of being paid. If the system fails to confirm any of the bill payment information, the system may display an error screen and an option to navigate back to the first web page.

If the system confirms the bill payment information, at step 628 the system may then pre-fill a payment form for the user. Pre-filling the payment form may include entering in the user payment account information, the user's billing address, and the billing account information. Part of pre-filling the payment form may include, at step 630, sending a query to STAMP for current balance information. At this point, STAMP may send additional calls to the web services of the utility to check the most current status of the bill. Thus, if the recipient paid the utility bill at some point after the last update to STAMP, the system would discover that the bill is no longer available to be paid and would return an error to the user.

If the bill is available to be paid and the user receives no errors, the user is presented with an authorization option. At step 632, the system receives an indication that the user has selected to pay the bill. Once the system receives a selection of the authorization button from the user, the authorization information is sent to STAMP. STAMP then connects to the utility, determines that the bill is still payable, verifies all of the payment information with the utility company, and pays the recipient bill. At step 634, after paying the recipient bill, STAMP may update the status of the bill to ‘paid.’ In future queries to the system, the paid bill may be excluded whenever a call is made to STAMP.

Once the system has verified completion of the bill payment transaction, at step 636 the system may check to determine if there are more eligible recipient accounts. If the system determines that more eligible accounts exist, the system may offer the user the option to make another payment. The system may make the offer without navigating the user to a different webpage. Alternatively, the system may navigate the user to the first webpage and repeat the steps of the user flow with the next eligible recipient account.

Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

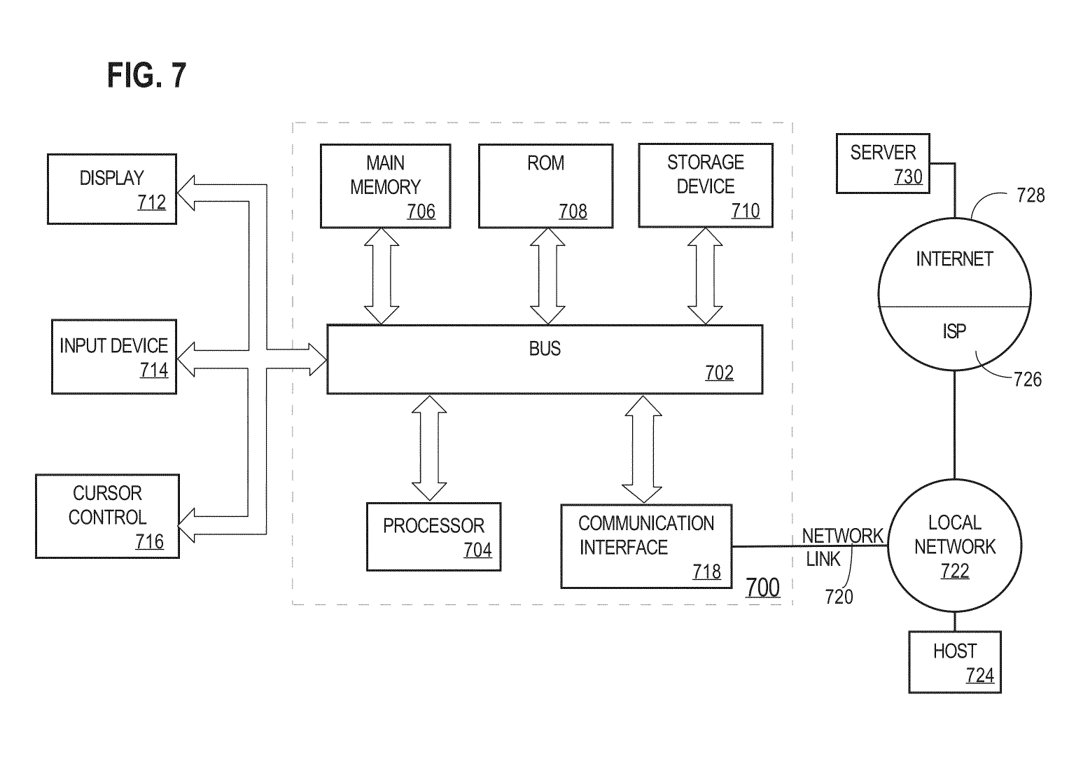

For example, FIG. 7 is a block diagram that depicts a computer system 700 upon which embodiments may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk, optical disk, or solid-state drive is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 710. Volatile media includes dynamic memory, such as main memory 706. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid-state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A data processing method, comprising:
storing, in a data repository of a server computer, user account information comprising identification of a plurality of user accounts and authorization data for each account of the plurality of accounts;
receiving, over a network at the server computer system, authentication data for a particular user of the plurality of users;
receiving, over a network at the server computer system, a request from the particular user account to transfer funds to a particular recipient;
in response to the request to transfer funds, storing, in a data repository of the server computer, particular recipient information comprising an identification of the particular recipient and an association between the particular recipient and the particular user;
using the particular recipient information, sending, over a network from the server computer system, a request to an application programming interface of one or more product or service providers for particular recipient account information for one or more particular recipient accounts with the one or more product or service providers;
receiving, over a network through the application programming interface of the one or more product or service providers, particular recipient account information for the one or more particular recipient accounts and storing the particular recipient account information in a data repository of the server computer system;
receiving, over a network at the server computer system, authentication data for the particular user;
in response to receiving the authentication data for the particular user, identifying the particular recipient based, at least in part, on the stored association between the particular recipient and the particular user;
in response to identifying the particular recipient, determining, from the particular recipient account information, that the one or more particular recipient accounts have a current balance;
causing displaying, through a graphical user interface executing on a client device associated with the particular user, a selectable option to pay a bill of the particular recipient.

2. The data processing method of claim 1, further comprising:
receiving, through a graphical user interface executing on the client device, a selection of the selectable option to pay the bill of the particular recipient;
using financial account information of the particular user, causing payment of the bill of the particular recipient;
updating the particular recipient account information stored in the data repository of the server computer system to indicate that the bill of the particular recipient has been paid.

3. The data processing method of claim 1, further comprising:
in response to determining, from the particular recipient account information stored in the data repository of the server computer system, that the one or more particular recipient accounts have a current balance, sending, over a network from the server computer system, an update request to an application programming interface of the one or more product or service providers for updated particular recipient account information for the one or more particular recipient accounts with the one or more product or service providers;
receiving over a network through the application programming interface of the one or more product or service providers, updated particular recipient account information for the one or more particular recipient accounts and storing the updated particular recipient account information in a data repository of the server computer system;
determining, from the updated particular recipient account information, that the one or more particular recipient accounts have a current balance and in response to determining, causing displaying, through the graphical user interface executing on the client device associated with the particular user the selectable option to pay the bill of the particular recipient.

4. The data processing method of claim 1, further comprising:
determining that a particular period of time has passed since the server computer system received particular recipient account information for the one or more particular recipient accounts and in response to determining that the particular period of time has passed, sending, over a network from the server computer system, an update request to an application programming interface of the one or more product or service providers for updated particular recipient account information for the one or more particular recipient accounts with the one or more product or service providers;
receiving over a network through the application programming interface of the one or more product or service providers, updated particular recipient account information for the one or more particular recipient accounts and storing the updated particular recipient account information in a data repository of the server computer system.

5. The data processing method of claim 1:
wherein the particular recipient information is a telephone number of the particular recipient;
wherein using the particular recipient information, sending, over a network from the server computer system, a request to an application programming interface of the one or more product or service providers for the particular recipient account information for the one or more particular recipient accounts with the one or more product or service providers comprises sending a request for accounts associated with the telephone number of the particular recipient.

6. The data processing method of claim 1, further comprising:
in response to receiving the authentication data for the particular user, identifying a second recipient based, at least in part, on a stored association between the second recipient and the particular user;
in response to identifying the second recipient, determining, from second recipient account information, that one or more second recipient accounts have a current balance;
selecting the one or more particular recipient accounts over the one or more second recipient accounts;
in response to selecting the one or more particular recipient accounts, causing displaying, through a graphical user interface executing on the client device associated with the particular user, the selectable option to pay a bill of the particular recipient.

7. The data processing method of claim 6, further comprising:
selecting the one or more particular recipient accounts over the one or more second recipients by determining one or more of:
the one or more particular recipient accounts maintain a lower balance than the one or more second recipient accounts;
the one or more particular recipient accounts maintain a higher balance than the one or more second recipient accounts;
a due date for payment of the one or more particular recipient accounts is sooner than a due date for payment of the one or more second recipient accounts;
the particular user has a history of paying bills associated with the one or more particular recipient accounts.

8. The data processing method of claim 1:
wherein the server computer system comprises:
a first database system housed in a first location to optimize integration with the one or more product or service providers and configured to send requests to the application programming interfaces of the one or more product or service providers and to receive recipient account information from the one or more product or service providers;
a second database system housed in a second location configured to receive the recipient account information from the first database system and interact with one or more client computing devices.

9. One or more non-transitory computer readable media storing instructions which, when executed by one or more processors, cause the one or more processors to perform:
storing, in a data repository of a server computer, user account information comprising identification of a plurality of user accounts and authorization data for each account of the plurality of accounts;
receiving, over a network at the server computer system, authentication data for a particular user of the plurality of users;
receiving, over a network at the server computer system, a request from the particular user account to transfer funds to a particular recipient;
in response to the request to transfer funds, storing, in a data repository of the server computer, particular recipient information comprising an identification of the particular recipient and an association between the particular recipient and the particular user;
using the particular recipient information, sending, over a network from the server computer system, a request to an application programming interface of one or more product or service providers for particular recipient account information for one or more particular recipient accounts with the one or more product or service providers;
receiving, over a network through the application programming interface of the one or more product or service providers, particular recipient account information for the one or more particular recipient accounts and storing the particular recipient account information in a data repository of the server computer system;
receiving, over a network at the server computer system, authentication data for the particular user;
in response to receiving the authentication data for the particular user, identifying the particular recipient based, at least in part, on the stored association between the particular recipient and the particular user;
in response to identifying the particular recipient, determining, from the particular recipient account information, that the one or more particular recipient accounts have a current balance;
causing displaying, through a graphical user interface executing on a client device associated with the particular user, a selectable option to pay a bill of the particular recipient.

10. The one or more non-transitory computer readable media of claim 9 wherein the instructions, when executed by the one or more processors, further cause performance of:
receiving, through a graphical user interface executing on the client device, a selection of the selectable option to pay the bill of the particular recipient;
using financial account information of the particular user, causing payment of the bill of the particular recipient;
updating the particular recipient account information stored in the data repository of the server computer system to indicate that the bill of the particular recipient has been paid.

11. The one or more non-transitory computer readable media of claim 9 wherein the instructions, when executed by the one or more processors, further cause performance of:
in response to determining, from the particular recipient account information stored in the data repository of the server computer system, that the one or more particular recipient accounts have a current balance, sending, over a network from the server computer system, an update request to an application programming interface of the one or more product or service providers for updated particular recipient account information for the one or more particular recipient accounts with the one or more product or service providers;
receiving over a network through the application programming interface of the one or more product or service providers, updated particular recipient account information for the one or more particular recipient accounts and storing the updated particular recipient account information in a data repository of the server computer system;
determining, from the updated particular recipient account information, that the one or more particular recipient accounts have a current balance and in response to determining, causing displaying, through the graphical user interface executing on the client device associated with the particular user the selectable option to pay the bill of the particular recipient.

12. The one or more non-transitory computer readable media of claim 9 wherein the instructions, when executed by the one or more processors, further cause performance of:
determining that a particular period of time has passed since the server computer system received particular recipient account information for the one or more particular recipient accounts and in response to determining that the particular period of time has passed, sending, over a network from the server computer system, an update request to an application programming interface of the one or more product or service providers for updated particular recipient account information for the one or more particular recipient accounts with the one or more product or service providers;
receiving over a network through the application programming interface of the one or more product or service providers, updated particular recipient account information for the one or more particular recipient accounts and storing the updated particular recipient account information in a data repository of the server computer system.

13. The one or more non-transitory computer readable media of claim 9:
wherein the particular recipient information is a telephone number of the particular recipient;
wherein using the particular recipient information, sending, over a network from the server computer system, a request to an application programming interface of the one or more product or service providers for the particular recipient account information for the one or more particular recipient accounts with the one or more product or service providers comprises sending a request for accounts associated with the telephone number of the particular recipient.

14. The one or more non-transitory computer readable media of claim 9 wherein the instructions, when executed by the one or more processors, further cause performance of:
in response to receiving the authentication data for the particular user, identifying a second recipient based, at least in part, on a stored association between the second recipient and the particular user;
in response to identifying the second recipient, determining, from second recipient account information, that one or more second recipient accounts have a current balance;
selecting the one or more particular recipient accounts over the one or more second recipient accounts;
in response to selecting the one or more particular recipient accounts, causing displaying, through a graphical user interface executing on the client device associated with the particular user, the selectable option to pay a bill of the particular recipient.

15. The one or more non-transitory computer readable media of claim 14 wherein the instructions, when executed by the one or more processors, further cause performance of:
selecting the one or more particular recipient accounts over the one or more second recipients by determining one or more of:
the one or more particular recipient accounts maintain a lower balance than the one or more second recipient accounts;
the one or more particular recipient accounts maintain a higher balance than the one or more second recipient accounts;
a due date for payment of the one or more particular recipient accounts is sooner than a due date for payment of the one or more second recipient accounts;
the particular user has a history of paying bills associated with the one or more particular recipient accounts.

16. A computer system comprising:
a memory;
one or more processors that are communicatively coupled to the memory and that are programmed to:
store user account information comprising identification of a plurality of user accounts and authorization data for each account of the plurality of accounts;
receive, over a network, authentication data for a particular user of the plurality of users;
receive, over a network, a request from the particular user account to transfer funds to a particular recipient;
in response to the request to transfer funds, store particular recipient information comprising an identification of the particular recipient and an association between the particular recipient and the particular user;
using the particular recipient information, send, over a network, a request to an application programming interface of one or more product or service providers for particular recipient account information for one or more particular recipient accounts with the one or more product or service providers;
receive, over a network through the application programming interface of the one or more product or service providers, particular recipient account information for the one or more particular recipient accounts and store the particular recipient account information;
receive, over a network at the server computer system, authentication data for the particular user;
in response to receiving the authentication data for the particular user, identify the particular recipient based, at least in part, on the stored association between the particular recipient and the particular user;
in response to identifying the particular recipient, determine, from the particular recipient account information, that the one or more particular recipient accounts have a current balance;
cause displaying, through a graphical user interface executing on a client device associated with the particular user, a selectable option to pay a bill of the particular recipient.

17. The system of claim 16, wherein the one or more processors are further configured to:
receive, through a graphical user interface executing on the client device, a selection of the selectable option to pay the bill of the particular recipient;
using financial account information of the particular user, cause payment of the bill of the particular recipient;
update the stored particular recipient account information to indicate that the bill of the particular recipient has been paid.

18. The system of claim 16, wherein the one or more processors are further configured to:
in response to determining, from the particular recipient account information stored in the data repository of the server computer system, that the one or more particular recipient accounts have a current balance, send, over a network from the server computer system, an update request to an application programming interface of the one or more product or service providers for updated particular recipient account information for the one or more particular recipient accounts with the one or more product or service providers;
receive over a network through the application programming interface of the one or more product or service providers, updated particular recipient account information for the one or more particular recipient accounts and store the updated particular recipient account information in a data repository of the server computer system;
determine, from the updated particular recipient account information, that the one or more particular recipient accounts have a current balance and in response to determining, cause displaying, through the graphical user interface executing on the client device associated with the particular user, the selectable option to pay the bill of the particular recipient.

19. The system of claim 16:
wherein the particular recipient information is a telephone number of the particular recipient;
wherein the one or more processors are configured to send the request to the application programming interface of the one or more product or service providers for the particular recipient account information for the one or more particular recipient accounts with the one or more product or service providers by sending a request for accounts associated with the telephone number of the particular recipient.

20. The system of claim 16, wherein the one or more processors are further configured to:
in response to receiving the authentication data for the particular user, identify a second recipient based, at least in part, on a stored association between the second recipient and the particular user;
in response to identifying the second recipient, determine, from second recipient account information, that one or more second recipient accounts have a current balance;
select the one or more particular recipient accounts over the one or more second recipient accounts by determining one or more of:
the one or more particular recipient accounts maintain a lower balance than the one or more second recipient accounts;
the one or more particular recipient accounts maintain a higher balance than the one or more second recipient accounts;
a due date for payment of the one or more particular recipient accounts is sooner than a due date for payment of the one or more second recipient accounts;
the particular user has a history of paying bills associated with the one or more particular recipient accounts;
in response to selecting the one or more particular recipient accounts, cause displaying, through a graphical user interface executing on the client device associated with the particular user, the selectable option to pay a bill of the particular recipient.
